(19) United States
(12) Patent Application Publication
(10) Pub. No.: US 2024/0273481 A1
(43) Pub. Date: Aug. 15, 2024

(54) INTEGRATION OF CHANNELS IN TRANSACTION SYSTEMS

(71) Applicant: Truist Bank, Charlotte, NC (US)

(72) Inventors: Kendra Henry, Charlotte, NC (US); Pramod Nambiar, Tega Cay, SC (US); Luana Peterman, Lancaster, SC (US)

(73) Assignee: Truist Bank, Charlotte, NC (US)

(21) Appl. No.: 18/107,759

(22) Filed: Feb. 9, 2023

(51) Int. Cl. G06Q 20/02; G06Q 20/42

(52) U.S. Cl. CPC G06Q 20/027; G06Q 20/42

(57) ABSTRACT

Transaction requests in a channel-specific format can be automatically transformed into a transaction processing format in transaction systems. For example, a system can receive, by a transaction management layer, a transaction request from a transaction channel in a channel-specific format associated with the transaction channel. The system can transform the transaction request into an internal specific format of the transaction management layer based on a first mapping from the channel-specific format to the internal specific format. Additionally, the system can transform the transaction request into a transaction processing format of a downstream transaction processing system based on a second mapping from the internal specific format to the transaction processing format. The system can send the transaction request in the transaction processing format to the downstream transaction processing system. The downstream transaction processing system can be configured to execute the transaction request in response to receiving the transaction request.

### TECHNICAL FIELD

The present disclosure relates generally to transaction systems, and more particularly, although not exclusively, to integration of channels in transaction systems.

### BACKGROUND

Transaction requests may originate at a transaction channel and be executed by a downstream processing system. Thus, a transaction request may need to be directed from the transaction channel to the downstream processing system via various intermediate components. The transaction channel may generate the transaction request in a particular format that is different than a format that the downstream processing system is capable of processing. Thus, it may be advantageous to streamline the conversion from the channel format to the downstream processing system.

### SUMMARY

According to one example of the present disclosure, a system can include a processor and a memory including instructions that are executable by the processor to perform operations. The operations can include receiving, by transaction management layer, a transaction request from a transaction channel of a plurality of transaction channels. The transaction request can be in a channel-specific format associated with the transaction channel. The operations can further include transforming the transaction request into an internal specific format of the transaction management layer based on a first mapping from the channel-specific format to the internal specific format and transforming the transaction request into a transaction processing format of a downstream transaction processing system based on a second mapping from the internal specific format to the transaction processing format. The operations can also include sending the transaction request in the transaction processing format to the downstream transaction processing system. The downstream transaction processing system can be configured to execute the transaction request in response to receiving the transaction request.

According to another example of the present disclosure, a non-transitory computer readable medium may contain instructions that are executable by a processor to cause the processor to perform operations. The operations may include receiving, by transaction management layer, a transaction request from a transaction channel of a plurality of transaction channels. The transaction request can be in a channel-specific format associated with the transaction channel. The operations can further include transforming the transaction request into an internal specific format of the transaction management layer based on a first mapping from the channel-specific format to the internal specific format and transforming the transaction request into a transaction processing format of a downstream transaction processing system based on a second mapping from the internal specific format to the transaction processing format. The operations can also include sending the transaction request in the transaction processing format to the downstream transaction processing system. The downstream transaction processing system can be configured to execute the transaction request in response to receiving the transaction request.

According to a further example of the present disclosure, a method involves receiving, by transaction management layer, a transaction request from a transaction channel of a plurality of transaction channels. The transaction request can be in a channel-specific format associated with the transaction channel. The method further involves transforming the transaction request into an internal specific format of the transaction management layer based on a first mapping from the channel-specific format to the internal specific format and transforming the transaction request into a transaction processing format of a downstream transaction processing system based on a second mapping from the internal specific format to the transaction processing format. The method also involves sending the transaction request in the transaction processing format to the downstream transaction processing system. The downstream transaction processing system can be configured to execute the transaction request in response to receiving the transaction request.

### BRIEF DESCRIPTION OF THE DRAWINGS

FIG. 1 is a schematic block diagram of an example of a system for implementing channel integration in a transaction system according to an example of the present disclosure.

FIG. 2 is a block diagram of another example of a system for implementing channel integration in a transaction system according to one example of the present disclosure.

FIG. 3 is a flowchart of a process for channel integration in a transaction system according to another example of the present disclosure.

### DETAILED DESCRIPTION

A transaction processing system can receive transaction requests to execute transactions. A transaction request can include transaction data with information such as a transaction amount, a transaction data, a transaction recipient account, a transaction sender account, a routing number, and the like. The transaction processing system can process the transaction request by performing actions to fulfill the transaction request. Conventionally, due to different channel-specific formats associated with each transaction request, the transaction processing system may rely on additional software applications to convert the different channel-specific formats to a transaction processing format used by the transaction processing system. So, transforming the transaction request to the transaction processing format is often time-consuming or resource intensive.

Aspects of the present disclosure provide a system that automatically transforms a channel-specific format of a transaction request to a transaction processing format of a transaction processing system through using an internal specific format. The internal specific format can be a format used by a transaction management layer of the transaction processing system. The transaction management layer can receive the transaction request from one or more transaction channels. In response to receiving the transaction request, the transaction management layer can access a database storing one or more mappings used to transform the channel-specific format to the internal specific format. Since the transaction channels may each use a different channel-specific format, the database can store a respective mapping to transform each different channel-specific format to the internal specific format. From the internal specific format, the transaction management layer can transform the transaction request into the transaction processing format. As a result, the transaction processing system can process the transaction request as received from the transaction processing layer.

Thus, an advantage of the system of the present disclosure is that the transaction management layer can automatically transform the transaction request from the channel-specific format to the transaction processing format. Using the internal specific format as an intermediate format between the channel-specific format and the transaction processing format enables flexibility associated with format processing for the transaction request. By accessing the database for the mappings, the transaction management layer can transform the transaction request without user input. In addition, the system can transform the transaction request without creating a new application to manage the format processing, thereby conserving computing resources.

The following illustrative examples are provided to introduce the reader to the general subject matter discussed herein, and are not intended to limit the scope of the disclosed concepts. In the following description, specific details are set forth in order to provide a thorough understanding of various implementations and examples. Various implementations may be practiced without these specific details. The figures and description are not intended to be restrictive.

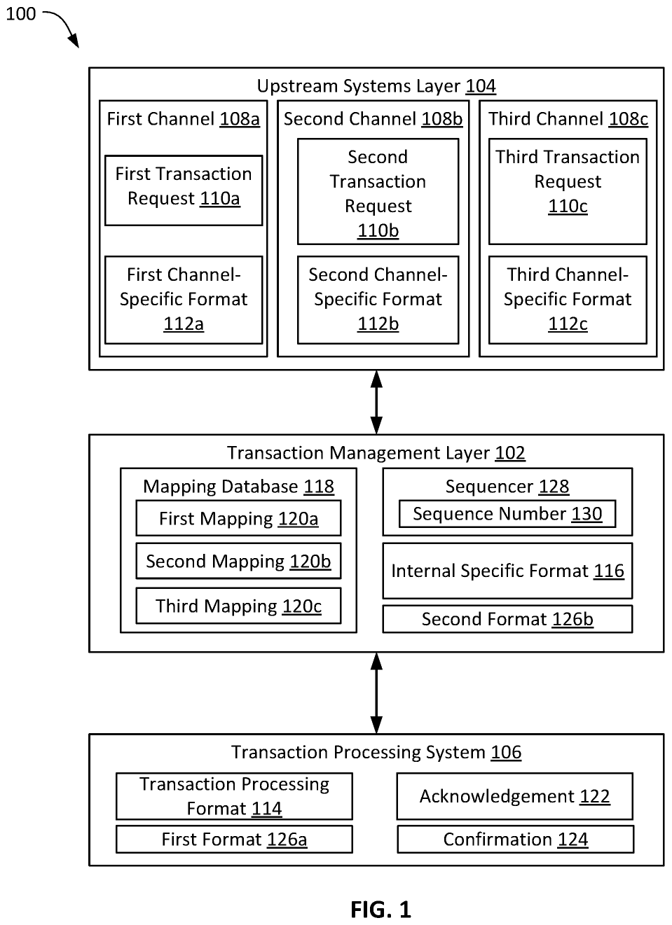

FIG. 1 is a schematic block diagram of an example of a system 100 for implementing channel integration in a transaction system according to an example of the present disclosure. The system 100 can include a transaction management layer 102 communicatively coupled to an upstream systems layer 104 and a transaction processing system 106. The upstream systems layer 104 may include channels 108a-c, which can be transaction channels through which users can transmit transaction requests 110 for subsequent processing. Examples of the channels 104a-c can include Loan IQ, Wire Payment Initiation, etc. In some examples, the transaction requests 110 can be wire payment requests.

The transaction management layer 102 can receive network-transmitted transaction requests 110a-c from the channels 108a-c. The transaction management layer 102 may perform various functions, such as but not limited to, integrating the channels 1048-c into an environment with various components and forwarding the transaction requests 110a-c to the transaction processing system 106.

In some examples, each of the channels 108a-c may have an associated channel-specific format in which they generate transaction requests 110a-c. That is, the first channel-specific format 112a of channel 108a may be different than the other channel-specific formats 112b-c of channels 108b-c. In an example, a first channel-specific format 112a of a first channel 108a may be a comma-separated values (CSV) file, a second channel-specific format 112b of a second channel 108b may be a messaging queue (MQ) message, and the channel-specific format of a third channel 108c may be an extensible markup language (XML) file. The information included in a transaction request 110 can include an identifier of a debtor, an identifier of a creditor, an amount of the transaction, a currency, etc.

The transaction processing system 106 may be incapable of processing a transaction request 110 as generated in the channel-specific format 112. Instead, the transaction processing system 106 may process transaction requests 110a-c received in a transaction processing format 114 from the transaction management layer 102. For example, the transaction processing system 106 may be a wire transfer system that uses wire instruction as the transaction processing format 114. The transaction management layer 102 can transform the transaction request 110 from the channel-specific format 112 to the transaction processing format 114 using an internal specific format 116.

Specifically, the transaction management layer 102 can process transaction requests 110 in an internal specific format 116 that may be different from each of the channel-specific formats 112. So, upon receiving a first transaction request 110a from channel 104a in a first channel-specific format 112a, the transaction management layer 102 can access a mapping database 118 to determine a mapping 120 from the first channel-specific format 112a to the internal specific format 116. The mapping database 118 can store a respective mapping from each channel-specific format into the internal specific format 116. When a new channel is integrated into the upstream systems layer 104, a new mapping from a corresponding channel-specific format for the new channel to the internal specific format 116 can be generated and stored in the mapping database 118.

Once the transaction management layer 102 accesses the mapping 120, the transaction management layer 102 can transform the transaction request 110 from the channel-specific format 112 into the internal specific format 116 based on the mapping 120. For example, the transaction management layer 102 can use a first mapping 120a to convert the first channel-specific format 112a of channel 104a from a CSV file to the internal specific format 116. The transaction management layer 102 additionally can access the mapping database 118 to determine a second mapping 120b to transform the transaction request 110 from the internal specific format 116 to the transaction processing format 114. This process can prevent allocating resources to create or use an additional software application in the system 100 to manage format processing for the transaction request 110, thereby reducing overall computing resources consumed by the system 100. Additionally, in some examples, the mapping database 118 may store a single second mapping 120b that is compatible with each transaction request in the internal specific format 116, thereby conserving storage resources.

Once the transaction request 110 is in the transaction processing format 114, the transaction management layer 102 can send the transaction request 110 to the transaction processing system 106 positioned downstream from the transaction management layer 102. The transaction processing system 106 may be referred to herein as a downstream transaction processing system. In some examples, the transaction management layer 102 may receive a message (e.g., an acknowledgement 122 or a confirmation 124) of an execution of the transaction request 110 from the transaction processing system 106. The transaction management layer 102 can receive the message in a first format 126a. Based on the first format 126a, the transaction management layer 102 can transform the message from the first format 126a into a second format 126b indicative of a corresponding transaction channel that generated the transaction request 110. The transaction management layer 102 then can send the message in the second format 126b to the corresponding channel 108.

If the transaction management layer 102 receives multiple transaction requests 110, the transaction processing system 106 may process the transaction requests 110 in a predetermined order. In such examples, the transaction management layer 102 can use a sequencer 128 to determine a sequence number 130 for each transaction request, thereby defining a sequence by which each transaction request is processed. For example, the sequencer 128 can be software that determines the sequence number 130 based on an order by which the transaction management layer 102 receives the transaction requests 110 from the upstream systems layer 104. Accordingly, the sequence defined by each sequence number 130 can match the predetermined order for the transaction processing system 106.

Based on the sequence number 130, the transaction management layer 102 can send the transaction request 110 to the transaction processing system 106. In some examples, a higher sequence number may result in a first transaction request 110a being sent after a second transaction request 110b with a lower sequence number. For example, if the transaction management layer 102 receives a set of transaction requests with five transaction requests, the sequence number 130 for the set of transaction requests can range from one to five. A first transaction request 110a assigned a sequence number of one may be sent first to the transaction processing system 106. A second transaction request 110b assigned a different sequence number of five can be sent last to the transaction processing system 106.

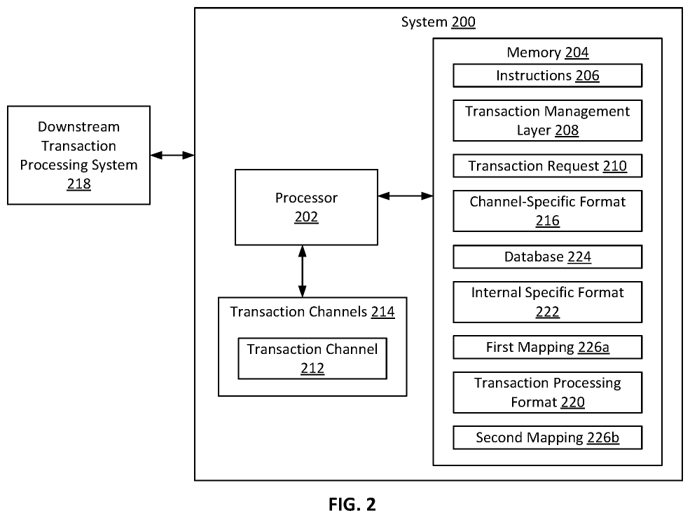

FIG. 2 is a block diagram of another example of a system 200 for implementing channel integration in a transaction system according to one example of the present disclosure. As depicted, the system 200 may include a processor 202 communicatively coupled to a memory 204. In some examples, the components shown in FIG. 2 can be integrated into a single structure. For example, the components can be within a single housing. In other examples, the components shown in FIG. 2 can be distributed (e.g., in separate housings) and in electrical communication with each other.

The processor 202 can execute one or more operations for implementing some examples. The processor 202 can execute instructions 206 stored in the memory 204 to perform the operations. The processor 202 can include one processing device or multiple processing devices. Non-limiting examples of the processor 202 include a Field-Programmable Gate Array (“FPGA”), an application-specific integrated circuit (“ASIC”), a microprocessor, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory 204 can be a non-transitory, computer-readable medium from which the processor 202 can read the instructions 206. A computer-readable medium can include electronic, optical, magnetic, or other storage devices capable of providing the processor 202 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 202 can read the instructions 206.

The processor 202 can execute the instructions 206 to perform operations. For example, the processor 202 can receive, by a transaction management layer 208, a transaction request 210 from a transaction channel 212 of a plurality of transaction channels 214. The transaction request 210 can be received in a channel-specific format 216 associated with the transaction channel 212. In some examples, a downstream transaction processing system 218 may be unable to process the transaction request 210 in the channel-specific format 216. Directly translating the transaction request 210 into a transaction processing format 220 used by the downstream transaction processing system 218 may limit flexibility for format processing of the transaction request 210. Instead, the processor 202 can translate the transaction request 210 into an internal specific format 222 used by the transaction management layer 208. The processor 202 may access a database 224 to determine a first mapping 226a used to translate the transaction request 210 from the channel-specific format 216 into the internal specific format 222. For example, the processor 202 can use the first mapping 226a to translate the transaction request 210 from a messaging queue (MQ) message to the internal specific format 222. The processor 202 additionally can access the database 224 to determine a second mapping 226b used to translate the transaction request 210 into the transaction processing format 220 used by the downstream transaction processing system 218. Once the transaction request 210 is in the transaction processing format 220, the processor 202 can send the transaction request 210 to the downstream transaction processing system 218 for processing.

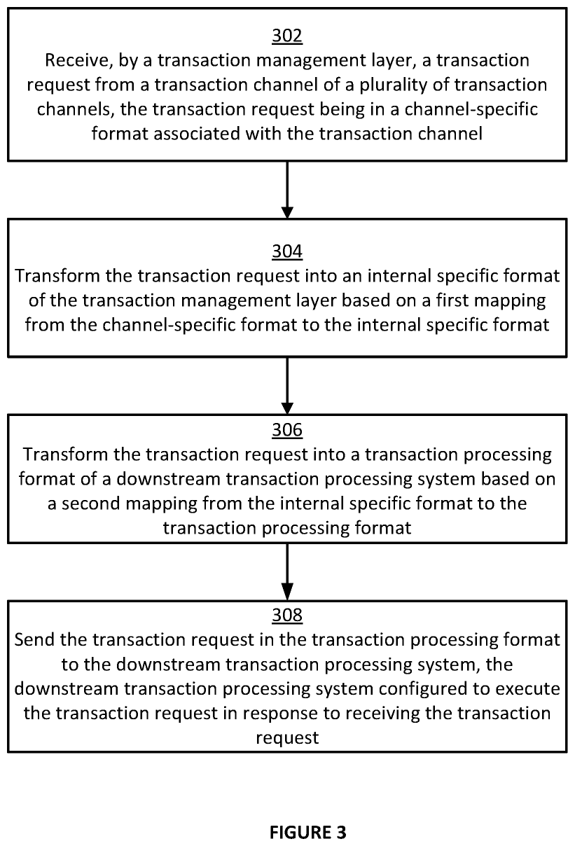

FIG. 3 is a flowchart of a process for channel integration in a transaction system according to another example of the present disclosure. The process of FIG. 3 can be implemented by the transaction management layer 102 of FIG. 1 or the system 200 of FIG. 2, but other implementations are also possible. While FIG. 3 depicts a certain sequence of steps for illustrative purposes, other examples can involve more steps, fewer steps, different steps, or a different order of the steps depicted in FIG. 3. The steps of FIG. 3 are described below with reference to the components of FIGS. 1-2 described above.

At block 302, the processor 202 receives, by a transaction management layer 208, a transaction request 210 from a transaction channel 212 of a plurality of transaction channels 214. The transaction request 210 can be in a channel-specific format 216 associated with the transaction channel 212. For example, the processor 202 may receive the transaction request 210 as a CSV file.

At block 304, the processor 202 transforms the transaction request 210 into an internal specific format 222 of the transaction management layer 208 based on a first mapping 226a from the channel-specific format 216 to the internal specific format 222. For example, the processor 202 can convert the transaction request 210 to the internal specific format 222 by using the first mapping 226a to transform data in the CSV file into the internal specific format 222. To determine the first mapping 226a, the processor 202 can access a database 224 storing a set of mappings between a plurality of channel-specific formats for the transaction channels 214 and the internal specific format 222. In some examples, the processor 202 may query the database 224 using an identifier based on the channel-specific format 216 to locate the first mapping 226a in the database 224. The processor 202 may update the database 224, for example by storing a new channel-specific format corresponding to a new transaction channel being integrated in the system 200.

At block 306, the processor 202 transforms the transaction request 210 into a transaction processing format 220 of a transaction processing system 218 based on a second mapping 226b from the internal specific format 222 to the transaction processing format 220. The processor 202 can access the database 224 that stores the second mapping 226b to then transform the transaction request 210 into the transaction processing format 220. In some examples, the database 224 may store a single second mapping 226b that the processor 202 uses to transform each transaction request 210 in the internal specific format 222 into the transaction processing format 220. Thus, the processor 202 may implement a relatively shorter response time to transform the transaction request 210 into the transaction processing format 220, thereby streamlining this transformation.

At block 308, the processor 202 sends the transaction request 210 in the transaction processing format 220 to the transaction processing system 218. The transaction processing system 218 can be configured to execute the transaction request 210 in response to receiving the transaction request 210. For example, if the transaction request 210 involves a wire transfer request, the transaction processing system 218 can transfer money from a transaction sender account to a transaction recipient account to execute the transaction request 210.

In some examples, in response, the processor 202 may receive an acknowledgement 122 or a confirmation 124 of an execution of the transaction request 210 from the transaction processing system 218 in a first format 126a. The first format 126a can correspond to a pathway through which each transaction request in the transaction processing format 220 are sent. The processor 202 then can transform the acknowledgement 122 or the confirmation 124 from the first format 126a into a second format 126b associated with the transaction channel 212. Once the acknowledgement 122 or the confirmation 124 is in the second format 126b, the processor 202 can send the acknowledgement 122 or the confirmation 124 to the transaction channel 212.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a memory including instructions that are executable by the processor to cause the processor to:
receive, by a transaction management layer, a transaction request from a transaction channel of a plurality of transaction channels, the transaction request being in a channel-specific format associated with the transaction channel;
transform the transaction request into an internal specific format of the transaction management layer based on a first mapping from the channel-specific format to the internal specific format;
transform the transaction request into a transaction processing format of a downstream transaction processing system based on a second mapping from the internal specific format to the transaction processing format; and
send the transaction request in the transaction processing format to the downstream transaction processing system, the downstream transaction processing system configured to execute the transaction request in response to receiving the transaction request.

2. The system of claim 1, wherein the transaction request is a first transaction request in a first channel-specific format from a first transaction channel, and wherein the memory includes instructions that are executable by the processor to cause the processor to:
receive, by the transaction management layer, a second transaction request from a second transaction channel of the plurality of transaction channels, the second transaction request being in a second channel-specific format that is different than the channel-specific format;
transform the second transaction request into the internal specific format of the transaction management layer based on a third mapping from the second channel-specific format to the internal specific format;
transform the second transaction request into the transaction processing format of the downstream transaction processing system based on the second mapping from the internal specific format to the transaction processing format; and
send the second transaction request in the transaction processing format to the downstream transaction processing system, the downstream transaction processing system configured to execute the second transaction request in response to receiving the second transaction request.

3. The system of claim 1, wherein the memory further includes instructions that are executable by the processor for causing the processor to:
determine a sequence number for the transaction request in a plurality of transaction requests;
set the sequence number for the transaction request in the transaction processing format; and
send the transaction request to the downstream transaction processing system based on the sequence number.

4. The system of claim 1, wherein the memory further includes instructions that are executable by the processor for causing the processor to:
access the first mapping and the second mapping from a database storing a set of mappings between a plurality of channel-specific formats for the plurality of transaction channels and the internal specific format and the second mapping between the internal specific format and the transaction processing format, wherein the set of mappings includes the first mapping.

5. The system of claim 1, wherein the memory further includes instructions that are executable by the processor for causing the processor to:
receive an acknowledgement or a confirmation of an execution of the transaction request from the downstream transaction processing system in a first format;
transform the acknowledgement or the confirmation into a second format associated with the transaction channel; and
send the acknowledgement or the confirmation in the second format to the transaction channel.

6. The system of claim 1, wherein the transaction request comprises a wire transfer request and the downstream transaction processing system comprises a wire transfer system.

7. The system of claim 1, wherein the channel-specific format comprises a comma-separated values file, a messaging queue message, or an extensible markup language file.

8. A non-transitory computer-readable medium comprising instructions that are executable by a processor for causing the processor to:
receive, by a transaction management layer, a transaction request from a transaction channel of a plurality of transaction channels, the transaction request being in a channel-specific format associated with the transaction channel;
transform the transaction request into an internal specific format of the transaction management layer based on a first mapping from the channel-specific format to the internal specific format;
transform the transaction request into a transaction processing format of a downstream transaction processing system based on a second mapping from the internal specific format to the transaction processing format; and
send the transaction request in the transaction processing format to the downstream transaction processing system, the downstream transaction processing system configured to execute the transaction request in response to receiving the transaction request.

9. The non-transitory computer-readable medium of claim 8, wherein the transaction request is a first transaction request in a first channel-specific format from a first transaction channel, and wherein the instructions further cause the processor to:
receive, by the transaction management layer, a second transaction request from a second transaction channel of the plurality of transaction channels, the second transaction request being in a second channel-specific format that is different than the channel-specific format;
transform the second transaction request into the internal specific format of the transaction management layer based on a third mapping from the second channel-specific format to the internal specific format;
transform the second transaction request into the transaction processing format of the downstream transaction processing system based on the second mapping from the internal specific format to the transaction processing format; and
send the second transaction request in the transaction processing format to the downstream transaction processing system, the downstream transaction processing system configured to execute the second transaction request in response to receiving the second transaction request.

10. The non-transitory computer-readable medium of claim 8, wherein the instructions further cause the processor to:
determine a sequence number for the transaction request in a plurality of transaction requests;
set the sequence number for the transaction request in the transaction processing format; and
send the transaction request to the downstream transaction processing system based on the sequence number.

11. The non-transitory computer-readable medium of claim 8, wherein the instructions further cause the processor to:
access the first mapping and the second mapping from a database storing a set of mappings between a plurality of channel-specific formats for the plurality of transaction channels and the internal specific format and the second mapping between the internal specific format and the transaction processing format, wherein the set of mappings includes the first mapping.

12. The non-transitory computer-readable medium of claim 8, wherein the instructions further cause the processor to:
receive an acknowledgement or a confirmation of an execution of the transaction request from the downstream transaction processing system in a first format;
transform the acknowledgement or the confirmation into a second format associated with the transaction channel; and
send the acknowledgement or the confirmation in the second format to the transaction channel.

13. The non-transitory computer-readable medium of claim 8, wherein the transaction request comprises a wire transfer request and the downstream transaction processing system comprises a wire transfer system.

14. The non-transitory computer-readable medium of claim 8, wherein the channel-specific format comprises a comma-separated values file, a messaging queue message, or an extensible markup language file.

15. A method comprising:
receiving, by a transaction management layer, a transaction request from a transaction channel of a plurality of transaction channels, the transaction request being in a channel-specific format associated with the transaction channel;
transforming the transaction request into an internal specific format of the transaction management layer based on a first mapping from the channel-specific format to the internal specific format;
transforming the transaction request into a transaction processing format of a downstream transaction processing system based on a second mapping from the internal specific format to the transaction processing format; and
sending the transaction request in the transaction processing format to the downstream transaction processing system, the downstream transaction processing system configured to execute the transaction request in response to receiving the transaction request.

16. The method of claim 15, wherein the transaction request is a first transaction request in a first channel-specific format from a first transaction channel, and wherein the method further comprises:
receiving, by the transaction management layer, a second transaction request from a second transaction channel of the plurality of transaction channels, the second transaction request being in a second channel-specific format that is different than the channel-specific format;
transforming the second transaction request into the internal specific format of the transaction management layer based on a third mapping from the second channel-specific format to the internal specific format;
transforming the second transaction request into the transaction processing format of the downstream transaction processing system based on the second mapping from the internal specific format to the transaction processing format; and
sending the second transaction request in the transaction processing format to the downstream transaction processing system, the downstream transaction processing system configured to execute the second transaction request in response to receiving the second transaction request.

17. The method of claim 15, further comprising:
determine a sequence number for the transaction request in a plurality of transaction requests;
set the sequence number for the transaction request in the transaction processing format; and
send the transaction request to the downstream transaction processing system based on the sequence number.

18. The method of claim 15, further comprising:
access the first mapping and the second mapping from a database storing a set of mappings between a plurality of channel-specific formats for the plurality of transaction channels and the internal specific format and the second mapping between the internal specific format and the transaction processing format, wherein the set of mappings includes the first mapping.

19. The method of claim 15, further comprising:
receive an acknowledgement or a confirmation of an execution of the transaction request from the downstream transaction processing system in a first format;
transform the acknowledgement or the confirmation into a second format associated with the transaction channel; and
send the acknowledgement or the confirmation in the second format to the transaction channel.

20. The method of claim 15, wherein the transaction request comprises a wire transfer request and the downstream transaction processing system comprises a wire transfer system.
